(19) United States
(12) Patent Application Publication
(10) Pub. No.: US 2006/0080245 A1
(43) Pub. Date: Apr. 13, 2006

(54) Negotiable instrument clearing server and method

(75) Inventors: Vincent Bahl, Durham, NH (US); Gregory E. Park, Stratham, NH (US)

Correspondence Address: TIMOTHY P. O'HAGAN, 8710 KILKENNY CT, FORT MYERS, FL, 33912, US

(73) Assignee: Bottomline Technologies (DE) Inc., Portsmouth, NH (US)

(21) Appl. No.: 11/240,424

(22) Filed: Sep. 30, 2005

Related U.S. Application Data
(63) Continuation-in-part of application No. 10/190,062, filed on Jul. 3, 2002.

(51) Int. Cl. G06Q 40/00

(52) U.S. Cl. 705/40; 705/42

(57) ABSTRACT

The present invention relates to a secure check clearing server. The check clearing server comprises a database for storing payment information associated with an issued check and a status indicator associated with the issued check. A clearing module receiving a clearing request message. The clearing request message includes payment information associated with a purported check. The payment information includes a core digital image of the purported check. The clearing module determines whether the purported check is unaltered and clearable and, if unaltered and clearable initiates clearing of the purported check. The purported check is determined to be unaltered if the payment information associated with the purported check matches the payment information associated with the issued check. The purported check is determined to be clearable if the issued check is not cleared or canceled.

### CROSS REFERENCE TO RELATED APPLICATIONS

The present application is a continuation in part of U.S. patent application Ser. No. 10/190,062 entitled A System and Method for Producing and Verifying Secure Negotiable Instruments, filed on Jul. 3, 2002. The contents of such patent application is hereby incorporated by reference.

### TECHNICAL FIELD

The present invention relates to improved systems and methods for initiating a process for clearing a negotiable instrument such as a check and, more particularly, to a system and method for validating a purported check and initiating clearing.

### BACKGROUND OF THE INVENTION

In the traditional banking system, clearing of a check requires physically transporting the original paper check document to each bank in a clearing chain for presentment and payment. This antiquated system is heavily dependent on air and truck transportation systems.

In October of 2004, a law commonly known as the Check Clearing for the 21^{st} Century Act (“Check 21”) went into effect. Check 21 is intended to reduce the time and cost associated with transporting each original paper check document through the banking system to the issuing bank.

Check 21 permits financial institutions to use digital images of checks to settle check payments electronically. More specifically, a bank in the clearing chain may scan the front side and back side of a check to create an electronic check clearing file. The electronic check clearing file can be passed to, and cleared by, other banks in the clearing chain.

When a financial institution scans an original paper check document to create an electronic check clearing file, the original paper check document is truncated. Truncation removes the original paper check document from the collection process so that it is never presented to the issuing bank for payment. Typically the original paper check document is destroyed.

Electronic clearing under Check 21 not only reduces a financial institutions costs, but is further expected to reduce fraud by both: i) reducing access to paper checks within the physical transportation clearing system; and ii) enable more rapid clearing of payments (e.g. reduce float time).

It should be appreciated that generating an electronic check clearing file and truncating the original paper check document differs from check conversion. Check conversion is a is a process whereby an electronic fund transfer for payment through Automated Clearing House (ACH) is generated in replacement of clearing a check. Using check conversion, an original paper check document is truncated, but no digital image is created to replace the original paper check document.

If any bank in the clearing chain does not have systems for processing the electronic check clearing file, a paper version of the digital image must be provided. The paper version is called a substitute check. The substitute check is a paper reproduction of an electronic image of the original paper check document.

FIG. 1 is a graphical representation of a substitute check 10. In order to meet the requirements of legislation, a substitute check 10 must: i) display both an accurate front side image 12 of the original paper check document and an accurate back side image 14 of the original paper check document including all endorsements and processing data (both the front side image 12 and the back side image 14 are typically printed slightly smaller than the original); ii) contain the routing, transit, and check numbers as part of a MICR line; iii) contain a legend 18 stating “This is a legal copy of your check. You can use it the same way you would use the original check”; iv) include identification 20 of the bank that created the electronic image and truncated the original check; and v) conform to specific industry standards regarding dimensions, paper stock, and other particulars for processing purposes. The front side image 12 and the back side image 14 are referred to herein as the core digital image. The routing, transit and check number as part of a MICR line, the legend, and other information are referred to as substitute check formatting.

One problem exists in that, as allowed by the legislation, any clearing bank can require delivery of a substitute check rather than accepting an electronic check clearing file. If a bank requires delivery of a substitute check the holder must incur the expense of generating a substitute check, securely transporting the substitute check, and securely delivering the substitute check to the clearing bank. The holder also incurs costs associated with additional “float time” generated by this process.

Another problem exists in that even if a bank prefers to accept an electronic check clearing file rather than a substitute check, compatibility issues may exist between the computer systems of the bank generating the electronic check clearing file and the computer systems of the bank receiving the electronic check clearing file.

Yet a third problem exists in that whether a check is cleared using check conversion, an electronic check clearing file, or a substitute check, the bank holding the account on which the check is drawn (the issuing bank) remains the point at which the check (whether an electronic check clearing file or a substitute check) is honored (or bounced) and neither the bank of deposit nor any other holder-in-due-course (such as a retail check cashing facility) has advance visibility as to whether the issuing bank will honor the check.

What is needed is a system and method that not only provides advance visibility into whether ran issuing bank will honor a check but also provides for rapidly and securely initiating the clearing process of a check by initiating an ACH payment, generating an electronic check clearing file for clearing, or generating a substitute check at a place proximate to the issuing bank to reduce costs and time delays associated with the traditional check clearing process.

### SUMMARY OF THE INVENTION

A first aspect of the present invention is to provide a secure check clearing server. The secure check clearing server comprises a database storing payment information associated with a plurality of issued checks.

A clearing module receives a clearing request message that includes payment information associated with a purported check—including a core digital image of the purported check (both front side and back side). The clearing request may be received from a bank of deposit or another holder-in-due-course such as a retail check cashing facility.

The clearing module determines whether the purported check is valid by determining whether the purported check is both unaltered and clearable.

Determining whether the purported check is unaltered comprises comparing payment information associated with the purported check to payment information associated with an issued check. The purported check is unaltered if the payment information associated with the purported check matches the payment information associated with the issued check.

The clearing module determines that the purported check is clearable if a status indicator associated with the issued check (stored in the database) indicates that the check remains payable. The purported check is un-clearable if the status indicator indicates that the issued check is one of cancelled or previously cleared.

The clearing module: i) initiates clearing of the purported check if the purported check is valid (e.g. unaltered and clearable); and ii) updates the status indicator associated with the issued check to indicate that a purported check has been cleared to prevent the clearing module from subsequently determining that a duplicate check is clearable.

The secure check clearing server may include a print format module for initiating clearing of a purported check by generating a print formatted object representing a substitute check. The substitute check includes the core digital image and the substitute check formatting. The print formatted object is then passed to a remote printing system for printing of the substitute check at a location proximate to the clearing bank. The print formatted object may be in compliance with a print formatted object protocol associated with the print system at which the substitute check is to be printed or the clearing bank to which the substitute check is to be presented for clearing.

The secure check clearing server may include an electronic check clearing module for initiating clearing of a purported check by generating electronic check clearing data. The electronic check clearing data includes a core digital image of the purported check (front side and back side) and is transferred to the clearing bank as part of an electronic check clearing file. Alternatively the electronic check clearing data may include a substitute check (e.g. the core digital image and the substitute check formatting). The electronic check clearing data and file may be in compliance with an electronic check clearing protocol associated with the clearing bank.

The secure check clearing server may further include a check conversion module for initiating an electronic payment (such as ACH) in replacement of clearing the purported check.

A second aspect of the present invention is to provide a method of initiating clearing of a purported check. The method comprises storing payment information associated with a plurality of issued checks in a database.

The method further includes receiving a clearing request message that includes payment information associated with a purported check. The clearing request message includes a core digital image of the purported check (both the front side and back side). The clearing request may be received from a bank of deposit or another holder-in-due-course such as a retail check cashing facility.

The method includes determining whether the purported check is valid by determining whether the purported check is both unaltered and clearable.

Determining whether the purported check is unaltered comprises comparing payment information associated with the purported check to payment information associated with an issued check. The purported check is unaltered if the payment information associated with the purported check matches the payment information associated with the issued check.

Determining whether the purported check is clearable comprises determining if a status indicator associated with the issued check (stored in the database) indicates that the check remains payable. The purported check is un-clearable if the status indicator indicates that the issued check is one of cancelled or previously cleared.

The method comprises, if the purported check is valid (e.g. both unaltered and clearable): i) initiating clearing of the purported check; and ii) updating the status indicator associated with the issued check to indicate that a purported check has been cleared to prevent the clearing module from subsequently determining that a duplicate check is clearable.

Initiating clearing of the purported check may comprise generating a print formatted object representing a substitute check (e.g. core digital image and substitute check formatting) and passing the print formatted object to a remote printing system for printing of the substitute check at a location proximate to the clearing bank. The print formatted object may be in compliance with a print formatted object protocol associated with the print system at which the substitute check is to be printed or the clearing bank to which the substitute check is to be presented for clearing.

Initiating clearing of the purported check may comprise generating electronic check clearing data including the digital image of the purported check (both front side and back side) and transferring the electronic check clearing data to the clearing bank. The electronic check clearing data and file may be in compliance with an electronic check clearing protocol associated with the clearing bank.

Initiating clearing of the purported check may comprise initiating an electronic payment (such as ACH) in replacement of clearing the purported check.

For a better understanding of the present invention, together with other and further aspects thereof, reference is made to the following description, taken in conjunction with the accompanying drawings, and its scope will be pointed out in the appended claims.

### BRIEF DESCRIPTION OF THE DRAWINGS

FIG. 1 is a diagram representing an exemplary substitute check as known in the art;

FIG. 2 is a block diagram representing an check clearing server in accordance with one embodiment of the present invention;

FIG. 3 is a ladder diagram representing exemplary check validation and clearing in accordance with one embodiment of the present invention;

FIG. 4 is a diagram representing an issued check file in accordance with one embodiment of the present invention;

FIG. 5 is a diagram representing an issued check file in accordance with one embodiment of the present invention;

FIG. 6 is a diagram representing exemplary database architecture for storing issued check information in accordance with one embodiment of the present invention;

FIG. 7 is a diagram representing a check clearing request in accordance with one embodiment of the present invention

FIG. 8 is a flow chart representing exemplary operation of a issued check module in accordance with one embodiment of the present invention; and

FIG. 9 is a flow chart representing exemplary operation of a check clearing module in accordance with one embodiment of the present invention.

### DETAILED DESCRIPTION OF THE EXEMPLARY EMBODIMENTS

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

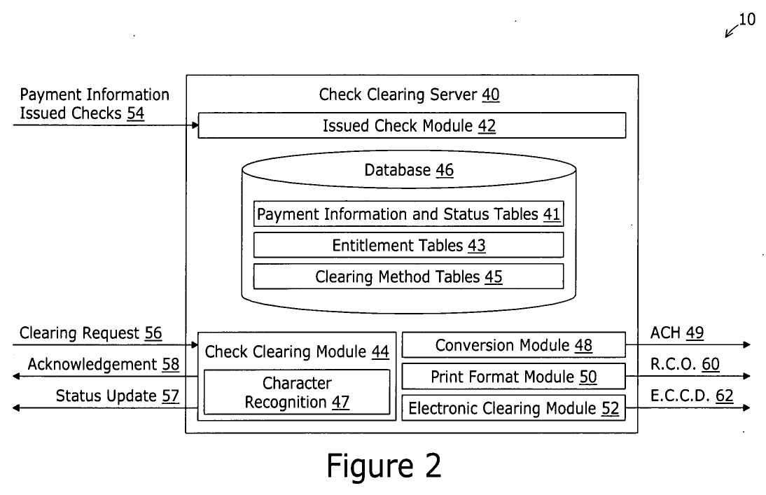

The block diagram of FIG. 2 represents a check clearing server 40 in accordance with one embodiment of the present invention. In general, the check clearing server 40 includes an issued check module 42 which receives payment information 54 related to a plurality of issued checks-and stores such payment information 54 within payment information and status tables 41 of a database 46. The payment information 54 may, for each issued check, include information identifying at least i) the financial institution and/or its routing number, ii) the account on which the issued check is drawn; iii) a check sequence number; iv) the payee; and v) a payment amount. It is envisioned that such payment information 54 may be provided to the issued check module 42 over a secure network or through a secure session over an open network such as the Internet by either the issuer or the financial institution holding the account on which the check is drawn.

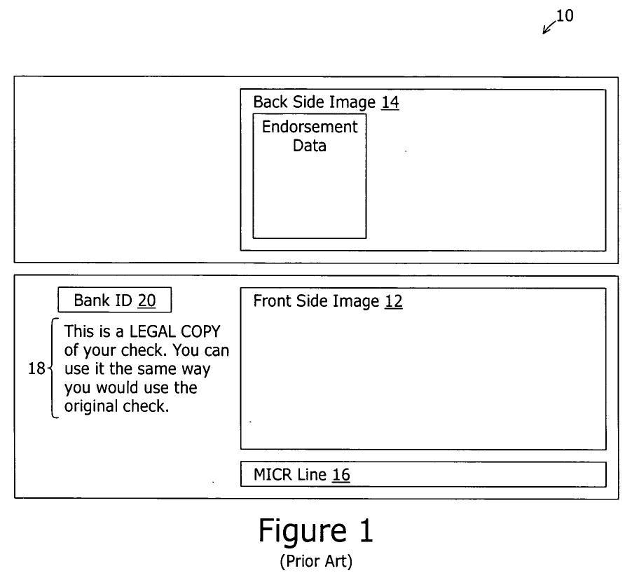

The check clearing server 40 includes a clearing module 44 which may receive a clearing request 56 which includes payment information from a purported check presented to a potential holder-in-due course. The purported check may be a check presented to a bank of deposit or presented to another potential holder-in-due-course such as a retail outlet that cashes third party checks. The payment information from the purported check may include information taken from the face of the purported check identifying at least i) the financial institution and/or its routing number, ii) the account on which the issued check is drawn; iii) a check sequence number; iv) the payee; and v) a payment amount. The payment information may further, or alternatively, include each of a face side image of the original paper check document and a backside image of the original paper check document (including all endorsements and processing data) such that a substitute check (as represented by FIG. 1) could be generated. If the clearing request 56 includes only the face side image and the back side image, a character recognition module 47 obtains, from the image of the face of the check, the payment information such as the i) the financial institution and/or its routing number, ii) the account on which the issued check is drawn; iii) a check sequence number; iv) the payee; and v) a payment amount from the face side image.

The clearing request 56 may be transferred to the check clearing server 40 by the bank of deposit or other holder-in-due-course: i) using a secure transport session over an open network such as the Internet; or ii) using application layer security and simple object access protocol (SOAP) messaging over an open network.

The clearing module 44 determines whether the purported check is valid by determining that it is both unaltered and clearable.

Determining whether a purported check is unaltered comprises comparing the payment information included in the clearing request 56 to the payment related to issued checks as stored in the database 41. If the payment information included in the clearing request 56 matches the payment information related to the issued check in the database 46, the check is unaltered.

Determining whether a purported check is clearable comprises checking a status indicator associated with the issued check. The status indicator may indicate whether such issued check is outstanding, cancelled, or cleared. If the issued check is outstanding, the unaltered purported check is clearable. If the issued check is canceled or cleared, the purported check is not clearable. In the case where the issued check has a status indicator of cleared, it is likely that the purported check is an unauthorized duplicate.

If the check is valid, clearing server 40 initiates clearing of the purported check to the issuing bank or next bank in the clearing chain (e.g. a clearing bank) by performing one of: i) converting the check payment to an ACH payment; ii) generating a substitute check for presentment; and ii) generating electronic check clearing data for presentment. The selection is based on criteria associated with the clearing bank. For example, the clearing bank may require presentment in the form of a substitute check or electronic check clearing data in a particular file format. An indicator of the clearing bank criteria may be stored in clearing method tables 45 of the database 46.

Presenting a substitute check comprises invoking operation of a print format module 50 to: i) generate a print formatted object representing a substitute check; and ii) transfer the print formatted object to a system proximate to the clearing bank (either controlled by the clearing bank or geographically close to the clearing bank so that the substitute check is easily delivered to the clearing bank without significant transportation costs) for printing of the substitute check. Selection of a particular format or protocol for the print formatted object (such as a PostScript file or a PCL file) is based on the requirements of the print system proximate to the clearing bank as stored in the clearing method tables 45 of the database 46.

Presenting electronic check clearing data comprises invoking operation of an electronic check clearing module 52 to build a message or file that includes the digital image of the purported check and other payment data associated with the purported check—in compliance with an electronic check clearing data and/or file protocol associated with the clearing bank. The electronic check clearing data is then transferred to the clearing bank's clearing systems.

Converting the payment of the purported check to an ACH payment comprises invoking operation of a conversion module 48 to generate an ACH transaction. The ACH transaction may be aggregated into an ACH file for clearing through known ACH clearing channels.

Along with presenting the purported check to the clearing bank, the check clearing module 44 may: i) update the status indicator associated with the issued check to indicated that it has cleared; ii) provide an acknowledgement message 58 in response to the clearing request 56 to confirm that the purported check is unaltered and clearable; and iii) provide a status update message 57 to the issuing bank indicating that the check has been deposited. Updating the status indicator prevents a duplicate of the issued check from subsequently being cleared.

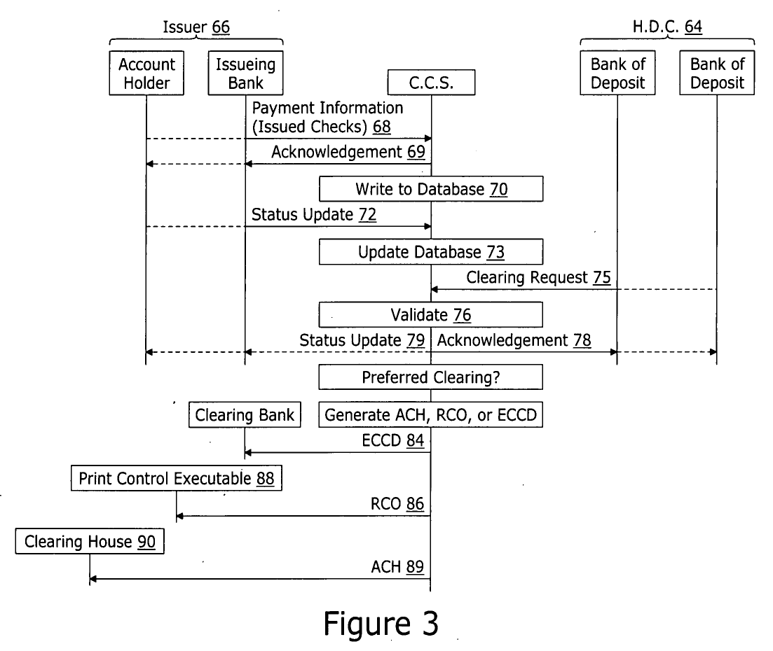

The ladder diagram of FIG. 3 represents exemplary operation of the check clearing server 40 in more detail. Turning to FIG. 3 in conjunction with FIG. 2, receipt of payment information 54 associated with one or more issued checks is represented by step 68. A secure transport session or a secure web services session may be established between the issuer 66 (e.g. either systems of the account holder or systems of the issuing bank) and the payment information 54 may be transferred through the secure session. The issued check module acknowledges receipt of the payment information 54 at step 69.

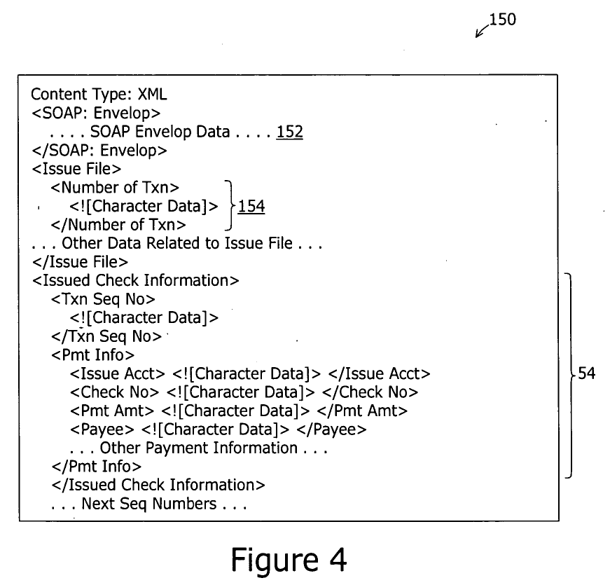

FIG. 4 represents an exemplary SOAP message 150 for delivery of payment information 54 in an extensible mark up language format. The SOAP message 150 does not include a digital image of each issued check. The message 150 includes: i) typical SOAP envelop data 152 to initiate appropriate handling by the issued check module 42; ii) data 154 related to the message 150 and/or all of the issued checks represented by the message 150; and iii) issued check information 54 related to each issued check.

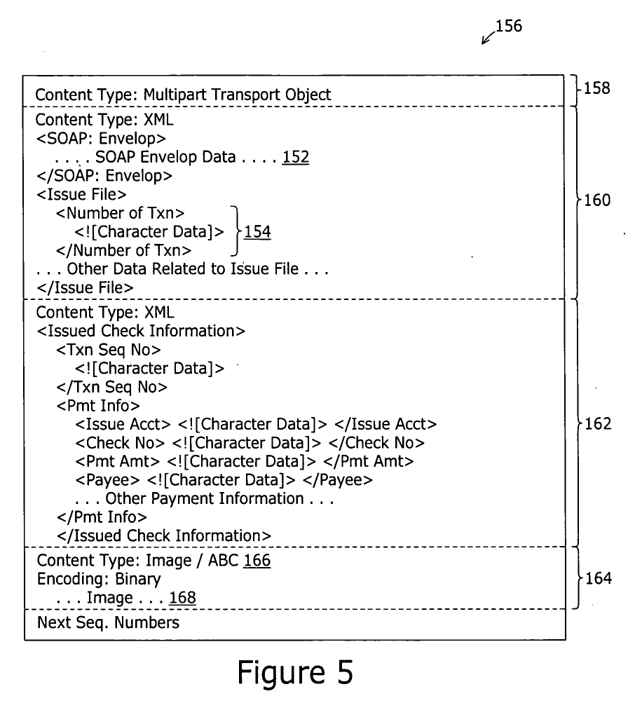

FIG. 5 represents an exemplary SOAP message 156 for delivery of payment information 54 that includes a digital image of each issued check. The message 156 is a multi part transport object such as an object compliant with one of the MIME protocols. Within FIG. 5, each hashed line represents delineation of each part of the multi part transport object. The message 156 includes a root part 158 identifying the message 156 as a multi part transport object.

An extensible mark up part 160 includes: i) typical SOAP envelop data 152 to initiate appropriate handling by the issued check module 42; and ii) data 154 related to the message 156 and/or all of the issued checks represented by the message 156.

The payment information 54 for each issued check comprises both an XML part 162 and a binary image part 164. The XML part 162 includes data such as: i) the financial institution and/or its routing number, ii) the account on which the issued check is drawn; iii) a check sequence number; iv) the payee; and v) a payment amount.

The binary image part may include an identifier 166 of the binary image format and binary data 168 representing the digital image of each of a face side image of the original paper check document and a backside image of the original paper check document.

Returning to FIG. 3, after receiving the payment information 54 at step 68 and acknowledging receipt at step 69, the issued check module 42 writes the payment information to the payment information and status tables 41 of the database 46 at step 70.

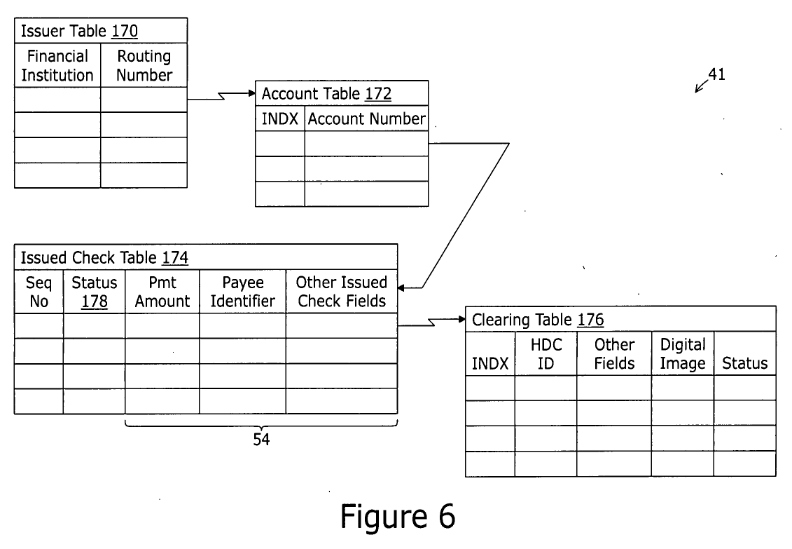

FIG. 6 represents an exemplary structure for the payment information and status tables 41. The structure includes a plurality of related tables. The root level key table may be an issuer table 170 associating each financial institution with its routing number. An account table 172 associates account numbers with the financial institution holding the account. An issued checks table 174 associates payment information 54 and a status identifier 178 for each issued check drawn on an account with the account. A clearing table 176 associates clearing information with each issued check. The clearing table 176 may include multiple records for each check if the check clearing server 40 is used multiple times for clearing a check within the clearing chain.

Returning to FIG. 3, step 72 represents receiving an update status message from the issuer 66. Such a status message may be sent to cancel an issued check. If such a message is received, the status identifier 178 (FIG. 6) may be updated to indicate that the check is cancelled at step 73—thereby making the check un-clearable.

Step 75 represents receipt of a clearing request 56. A secure transport session or a secure web services session may be established between the check clearing server 40 and the holder in due course 64 (e.g. either the bank of deposit or another holder-in-due-course such as a retail check cashing facility) and the clearing request 56 may be transferred through the secure session.

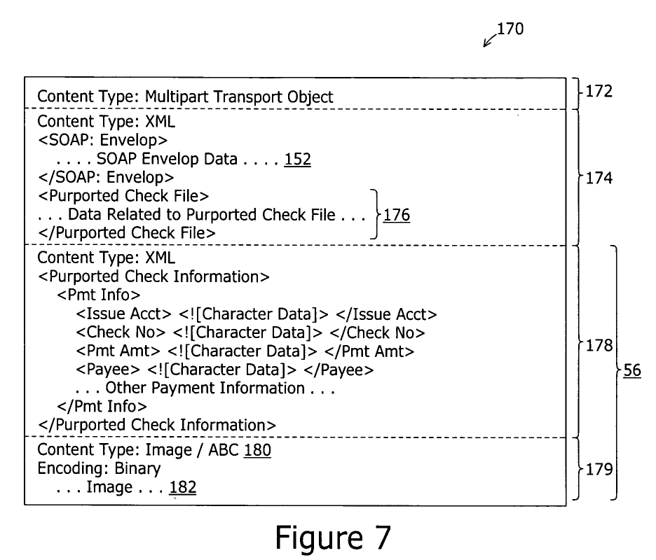

FIG. 7 represents an exemplary SOAP message 170 for delivery of a clearing request 56. The message 170 is a multi part transport object and each hashed line within FIG. 7 represents delineation of each message part. A root part 172 identifies the message as a multi part transport object.

An extensible mark up part 174 includes: i) typical SOAP envelop data 152 to initiate appropriate handling by the check clearing module 44; and ii) data 176 identifying the message as a clearing request 56.

The purported check information of the clearing request 56 comprises both an XML part 178 and a binary image part 179. The binary image part 179 may include an identifier 180 of the binary image format and binary image data 182 representing the digital image of each of a face side image of the original paper check document and a backside image of the original paper check document.

Returning to FIG. 3, step 76 represents the check clearing server 40 validating the purported check by determining whether the purported check is both unaltered and clearable.

Step 78 represents returning an acknowledgment 58 back to the holder-in-due-course 64. The acknowledgment 58 will indicate that the check is invalid if the check is altered or un-clearable. The acknowledgement 58 will indicate that the check is valid if it is both unaltered and clearable.

Step 79 represents sending a status message to the issuer 66 indicating that the check has been deposited (or if invalid) declined as invalid.

Step 80 represents looking up the preferred clearing method in clearing method tables 45 to determine how the clearing bank prefers the purported check to be cleared; and step 82 represents performing one of: i) converting the check payment to an ACH payment; ii) generating a print formatted object of a substitute check for presentment; and ii) generating electronic check clearing data for presentment. It should be appreciated that step 82 may be performed as a batch process for multiple checks—not necessarily on a check by check basis when a clearing request is received.

Steps 84, 86, and 89 each represent initiating clearing of the purported check by: i) building a message that includes the digital image of the purported check and other payment data associated with the purported check—in compliance with an electronic check clearing protocol associated with the clearing bank and delivering such message to the clearing bank; ii) transferring the print formatted object to a system proximate to the clearing bank (a print control executable 88) for printing of the substitute check; ii) and iii) building an ACH transaction file that includes an ACH conversion of the purported check and transferring the ACH transaction file to the clearing house 90. The appropriate one of steps 84, 86, and 89 is performed for each cleared check.

Building a message that includes the digital image of the purported check and other payment data associated with the purported check and delivering such message to the clearing bank may use techniques described in U.S. patent application Ser. No. 11/081,033, filed Mar. 12, 2005 and which is assigned to the same assignee of the present invention. The contents of U.S. patent application Ser. No. 11/081,033 is incorporated herein by reference.

Transferring the print formatted object to a system proximate to the clearing bank (a print control executable 88) for printing of the substitute check may use techniques described in U.S. patent application Ser. No. 11/152,450, filed Jun. 14, 2005 and which is assigned to the same assignee of the present invention. The contents of U.S. patent application Ser. No. 11/152,450 is incorporated herein by reference.

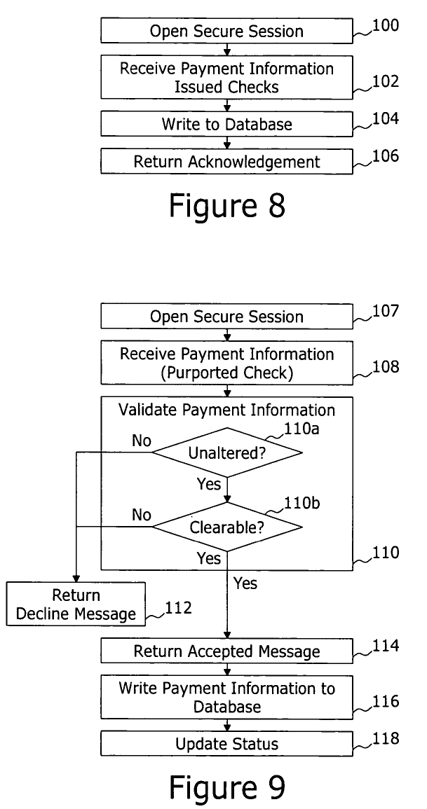

The flow chart of FIG. 8 represents exemplary operation of the issued check module 42 of the check clearing server 40. Referring to FIG. 8 in conjunction with FIG. 2, step 100 represents opening a secure transport session or secure web services session with the issuer system 66 (FIG. 3)—which as discussed may be systems of the account holder or systems of the issuing bank. Opening the secure session comprises authenticating the user of the issuer system 66 by comparing authentication information (such as group ID, user ID, and password) to entitlement information stored in entitlement tables 43 of the database 46.

Step 102 comprises receiving payment information associated with issued checks through the secure transport session. Step 102 corresponds to step 68 in the ladder diagram of FIG. 3.

Step 104 represents writing the payment information associated with each issued check to the database 46. Step 104 corresponds to step 70 of the ladder diagram of FIG. 3.

Step 106 represents returning an acknowledgement back to the issuer 66. Step 106 corresponds to step 69 in the ladder diagram of FIG. 3.

The flow chart of FIG. 9 represents exemplary operation of the check clearing module 44 of the check clearing server 40. Referring to FIG. 9 in conjunction with FIG. 2, step 107 represents opening a secure transport session or secure web services session with the holder-in-due-course system 64—which, as discussed, may be a bank of deposit or another holder-in-due-course such as a retail check cashing facility. Opening the secure session comprises authenticating the user of the holder-in-due-course system 64.

Step 108 comprises receiving payment information associated a purported check through the secure session. Step 108 corresponds to step 75 in the ladder diagram of FIG. 3.

Step 110 represents validating the payment information of the purported check. As discussed, validating the payment information comprises determining that the purported check is unaltered as sub-step 110a and determining that the purported check is clearable at sub-step 110b. Step 110 corresponds to step 76 of the ladder diagram of FIG. 3.

If the purported check does not validated, an acknowledgement message indicating that the purported check is declined is returned to the holder-in-due-course 64 at step 112. If the purported check is validated, an acknowledgment message indicated that the purported check has been accepted for clearing is returned to the holder-in-due-course 64 at step 114. Steps 112 and 114 correspond to step 78 of the ladder diagram of FIG. 3.

Step 116 represents writing payment information from the purported check to the database 46. It should be appreciated that clearing of purported checks, whether by conversion to ACH, delivery of electronic check clearing data as part of an electronic check clearing file, or printing of substitute checks is typically performed on a batch basis at a time schedule by the clearing system. As such, the payment information from the purported check is written to the database where it is held until such time as batch processing is performed.

Step 118 represents updating the status indicator 178 (FIG. 6) associated with the issued check—corresponding to the purported check—to indicate a cleared status to prevent clearing of a duplicate check.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A secure check clearing server comprising:
a database storing payment information associated with an issued check;
a clearing module for;
receiving a clearing request message, the clearing request message including payment information associated with a purported check, the payment information including a core digital image of the purported check; and
comparing payment information associated with the purported check to payment information associated with an issued check and determining that the purported check is unaltered if the payment information associated with the purported check matches the payment information associated with the issued check;
initiating clearing of the purported check if the purported check is unaltered.

2. The secure check clearing server of claim 1, further comprising:
a print format module for initiating clearing of a purported check by:
generating a print formatted object representing a substitute check, the substitute check comprising the core digital image and substitute check formatting, the print formatted object being in compliance with a print formatted object protocol associated with a remote print system to which the print formatted object is to be sent for printing; and
passing the print formatted object to the remote print system for printing of the substitute check at a location proximate to a clearing bank to which the substitute check is to be presented.

3. The secure check clearing server of claim 2, further comprising:
an electronic check clearing module for initiating clearing of a purported check by:
generating electronic check clearing data including the core digital image of the purported check, the electronic check clearing data being in compliance with an electronic check clearing protocol associated with the clearing bank; and
transferring the electronic check clearing data to the clearing bank.

4. The secure check clearing server of claim 3, further comprising a check conversion module for initiating an electronic payment in replacement of clearing the purported check.

5. The secure check clearing server of claim 1, further comprising:
an electronic check clearing module for initiating clearing of a purported check by:
generating electronic check clearing data including the core digital image of the purported check, the electronic check clearing data being in compliance with an electronic check clearing protocol associated with the clearing bank; and
transferring the electronic check clearing data to the clearing bank.

6. The secure check clearing server of claim 1, wherein:
the database further stores a status indicator associated with the issued check;
the clearing module:
further determines that the purported check is clearable if the status indicator indicates that the check remains payable;
initiates clearing of the purported check if the purported check is both unaltered and clearable; and
updates the status indicator associated with the issued check to indicate that a purported check has been cleared to prevent the clearing module from subsequently determining that a duplicate check is clearable.

7. The secure check clearing server of claim 6, wherein the clearing module further returns an acknowledgment in response to the clearing request message, the acknowledgement indicating;
that the purported check is valid if the purported check is both unaltered and clearable; and
that the purported check is invalid if the purported check is altered or un-clearable.

8. The secure check clearing server of claim 7, further comprising:
a print format module for initiating clearing of a purported check by:
generating a print formatted object representing a substitute check, the substitute check comprising the core digital image and substitute check formatting, the print formatted object being in compliance with a print formatted object protocol associated with a remote print system to which the print formatted object is to be sent for printing; and
passing the print formatted object to the remote print system for printing of the substitute check at a location proximate to a clearing bank to which the substitute check is to be presented.

9. The secure check clearing server of claim 8, further comprising:
an electronic check clearing module for initiating clearing of a purported check by:
generating electronic check clearing data including the core digital image of the purported check, the electronic check clearing data being in compliance with an electronic check clearing protocol associated with the clearing bank; and
transferring the electronic check clearing data to the clearing bank.

10. The secure check clearing server of claim 9, further comprising a check conversion module for initiating an electronic payment in replacement of clearing the purported check.

11. The secure check clearing server of claim 7, further comprising:
an electronic check clearing module for initiating clearing of a purported check by:
generating electronic check clearing data including the core digital image of the purported check, the electronic check clearing data being in compliance with an electronic check clearing protocol associated with the clearing bank; and
transferring the electronic check clearing data to the clearing bank.

12. A method of initiating clearing of a purported check, the method comprising
receiving payment information associated with an issued check;
storing the payment information associated with the issued check in a database;
receiving a clearing request message, the clearing request message including payment information associated with a purported check, the payment information including a core digital image of the purported check; and
comparing payment information associated with the purported check to payment information associated with an issued check and determining that the purported check is unaltered if the payment information associated with the purported check matches the payment information associated with the issued check;
initiating clearing of the purported check if the purported check is unaltered.

13. The method of claim 12, wherein initiating clearing of the purported check comprises:
generating a print formatted object representing a substitute check, the substitute check comprising the core digital image and substitute check formatting, the print formatted object being in compliance with a print formatted object protocol associated with a remote print system to which the print formatted object is to be sent for printing; and
passing the print formatted object to the remote print system for printing of the substitute check at a location proximate to a clearing bank to which the substitute check is to be presented.

14. The method of claim 13, wherein initiating clearing of the purported check comprises:
generating electronic check clearing data including the core digital image of the purported check, the electronic check clearing data being in compliance with an electronic check clearing protocol associated with the clearing bank; and
transferring the electronic check clearing data to the clearing bank.

15. The method of claim 14, wherein initiating clearing of the purported check comprises initiating an electronic payment in replacement of clearing the purported check.

16. The method of claim 12, wherein initiating clearing of the purported check comprises:
generating electronic check clearing data including the core digital image of the purported check, the electronic check clearing data being in compliance with an electronic check clearing protocol associated with the clearing bank; and
transferring the electronic check clearing data to the clearing bank.

17. The method of claim 12:
further comprising:
storing a status indicator associated with the issued check in the database; and
determining that the purported check is clearable if the status indicator indicates that the check remains payable;
the step of initiating clearing of the purported check occurs only if the purported check is both unaltered and clearable; and
the method further includes updating the status indicator associated with the issued check to indicate that a purported check has been cleared to prevent the clearing module from subsequently determining that a duplicate check is clearable.

18. The method of claim 17, further comprising returning an acknowledgment in response to the clearing request message, the acknowledgement;
including an indication that the purported check is valid if the purported check is both unaltered and clearable;
including an indication that the purported check is invalid if the purported check is altered or un-clearable.

19. The method of claim 18, wherein initiating clearing of the purported check comprises:
generating a print formatted object representing a substitute check, the substitute check comprising the core digital image and substitute check formatting, the print formatted object being in compliance with a print formatted object protocol associated with a remote print system to which the print formatted object is to be sent for printing; and
passing the print formatted object to the remote print system for printing of the substitute check at a location proximate to a clearing bank to which the substitute check is to be presented.

20. The method of claim 19, wherein initiating clearing of the purported check comprises:
generating electronic check clearing data including the core digital image of the purported check, the electronic check clearing data being in compliance with an electronic check clearing protocol associated with the clearing bank; and
transferring the electronic check clearing data to the clearing bank.

21. The method of claim 20, wherein initiating clearing of the purported check comprises initiating an electronic payment in replacement of clearing the purported check.

22. The method of claim 18, wherein initiating clearing of the purported check comprises:
generating electronic check clearing data including the core digital image of the purported check, the electronic check clearing data being in compliance with an electronic check clearing protocol associated with the clearing bank; and
transferring the electronic check clearing data to the clearing bank.
